(19) United States
(12) Patent Application Publication
(10) Pub. No.: US 2004/0139611 A1
(43) Pub. Date: Jul. 22, 2004

(54) Multi-layered comfort strip

(75) Inventor: William E. Vreeland, Shelton, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/733,543

(22) Filed: Dec. 11, 2003

Related U.S. Application Data
(60) Provisional application No. 60/433,398, filed on Dec. 13, 2002.

(51) Int. Cl. B26B 19/44

(52) U.S. Cl. 30/41

(57) ABSTRACT

A multi-layered comfort strip secured to a razor body includes a first layer and a second layer. The first layer is mated to the second layer and the second layer is secured to the razor body. The first material composition of the first layer differs from the second material composition of the second layer.

### CROSS-REFERENCE TO RELATED APPLICATINS

This application is entitled to the benefit of and incorporates by reference essential subject matter disclosed in Provisional Patent Application No. 60/433,398 filed on Dec. 13, 2002.

### FIELD OF THE INVENTION

This invention relates in general to a multi-layered comfort strip, and deals more particularly with a multi-layered comfort strip typically disposed adjacent to blade elements of a razor.

### BACKGROUND OF THE INVENTION

Over the years, many improvements have been made to razors in order to make such razors more comfortable to use and more efficient at their intended task. Towards this end, many hand held razors now employ a comfort strip oriented adjacent the blade elements of the razor. These comfort strips are usually located near the blade elements of a razor approximately parallel to the cutting edges defined thereby so that the comfort strip and the blade elements move together across a hirsute surface during a shaving operation. In effect, the comfort strip acts to lubricate or moisturize the affected body part in an effort to ameliorate any irritation, which may be caused by the passage of the blade elements themselves. It is therefore not uncommon for comfort strips to be comprised of oils, creams, soaps or other shaving aids.

Given their purpose, it is imperative that a comfort strip be securely attached to the razor body or, in the case of a disposable razor cartridge, to the cartridge, in order to provide its intended benefit over the useable life of the razor. In many cases, the comfort strip is securely attached to either a metallic or plastic portion of the razor, either through adhesion or by way of a mechanical device.

Difficulties exist, however, with securing the comfort strip to the plastic or metallic surfaces of the razor due to the inherent differences between the thermal expansion of the comfort strip and the razor surface. The specific characteristics of the comfort strip itself, specifically the soap formulations which include the use of oils and creams to promote lubricity, further complicates the bonding process. It is also oftentimes difficult for the user of a razor to accurately determine when the lubricating components of the mounted comfort strip have been depleted.

There therefore exists a need in the art for a comfort strip which not only accomplishes the objective of soothing the shaved portions of skin, but also one which may be more securely fixed to the body of a razor. Moreover, there exists a need in the art for a mechanism by which a user may determine if the comfort strip has been depleted prior to its use.

With the forgoing problems and concerns in mind, it is the general object of the present invention to provide a comfort strip for razors which overcomes or improves upon the above-described drawbacks.

### SUMMARY OF THE INVENTION

The present invention is directed in one aspect to a multi-layered comfort strip that is secured to a razor body. The comfort strip includes a first layer of material that is defined at least in part by a shaving aid. A second layer of material is also defined at least in part by a shaving aid and is mated to the first layer with the second layer being secured to the razor body. The first layer of material defines a first coefficient of thermal expansion that is different from a second coefficient of thermal expansion as defined by the second layer of material, the second coefficient of thermal expansion being closer to the coefficient of thermal expansion defined by the razor body, than is the first coefficient of thermal expansion.

The fact that the second coefficient of thermal expansion more closely matches the coefficient of thermal expansion defined by the razor body than does the first coefficient of thermal expansion provides for a better bond between the second layer of material and the razor body than would be possible if the comfort strip were composed entirely of the first layer of material.

Preferably, the first layer of material incorporates more shaving aid into its composition than does the second layer of material. In addition, it is also preferable that the first and second layers be coextruded. This allows for ease of manufacture, reduced, if any, handling of individual layers of material, and is more economical than a manual process.

In order to alert a user to the fact that the first layer of material is depleted, one embodiment of the present invention employs a differing color for each layer of material.

According to one embodiment of the present invention a multi-layered comfort strip secured to a razor body includes a first layer and a second layer. The first layer is mated to the second layer and the second layer is secured to the razor body. The first material composition of the first layer differs from the second material composition of the second layer.

### BRIEF DESCRIPTION OF THE DRAWINGS

FIG. 1 is a front view of a razor including a comfort strip, according to one embodiment of the present invention.

FIG. 2 is a partial, enlarged, cross-sectional view of the comfort strip and razor head portion of FIG. 1.

FIG. 3 is a cross-sectional view of an adhesive layer for securely fixing the comfort strip to the razor head portion, according to one embodiment of the present invention.

FIG. 4 is a cross-sectional view of a structural mechanism for securely fixing the comfort strip to the razor head portion, according to one embodiment of the present invention.

FIG. 5 is a cross-sectional view of a structural mechanism for securely fixing the comfort strip to the razor head portion, according to another embodiment of the present invention.

FIG. 6 is a cross-sectional view of a structural mechanism for securely fixing the comfort strip to the razor head portion, according to another embodiment of the present invention.

FIG. 7 is a cross-sectional view of the comfort strip illustrated in FIG. 1 which has been worn through use.

FIG. 8 is a front view of a razor including multiple comfort strips, according to another embodiment of the present invention.

### DETAILED DESCRIPTION OF THE PREFERRED EMBODIMENT

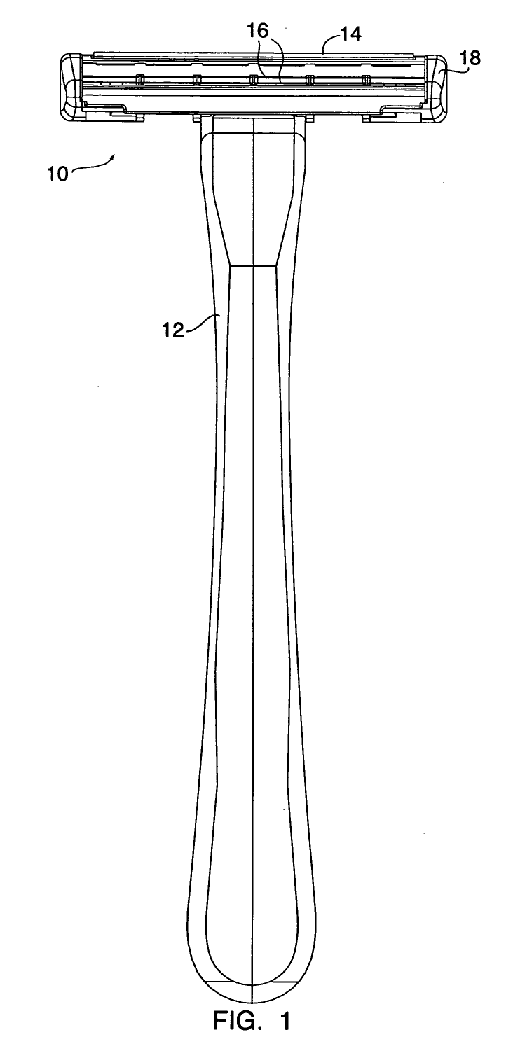

As shown in FIG. 1 a razor 10 includes a shaft, or handle 12, a comfort strip 14, and blade elements 16 mounted in a head, or cartridge, portion 18 of the razor 10. The comfort strip 14 is disposed adjacent to the blade elements 16 and is also mounted on the head portion 18.

While a razor 10 has been shown to include a pair of blade elements 16, the present invention is not limited in this regard as a razor having more or less than two blade elements is equally contemplated by the present invention. In addition, the present invention is not limited as to the specific type or structural form of razor shown in FIG. 1, the comfort strip of the present invention being equally adaptable to a single use razor, a razor having a replaceable cartridge, or the like, without departing from the broader aspects of the present invention.

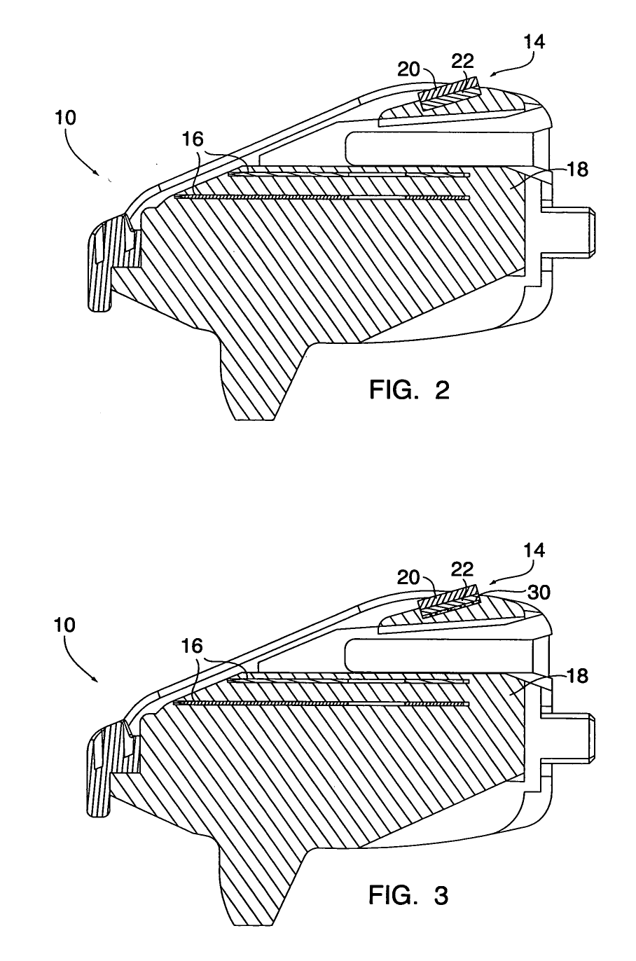

As shown in FIG. 2, the comfort strip 14 includes a first layer of material 20 and a second base layer of material 22 fixed to the first layer 20 in a laminated fashion. The first layer 20 shown in FIG. 2 is comprised at least in part of one or more shaving aids. Among other things, the shaving aids ameliorates any irritation which may be caused by the passage of the blade elements 16 during a shaving operation. Any number of known lubricating and/or moisturizing elements may be utilized in the formation of the first layer 20, including oils, creams, soap and soap-like formulations.

As shown in FIG. 2, the base layer 22 is also comprised of a shaving aid but further preferably includes those materials which are optimized to assist in the fixing of the comfort strip 14 to the head portion 18 of the razor 10. In particular, the base layer 22 includes certain ingredients or fillers which cause the base layer 22 to more closely match, as compared to the first layer 20, the thermal expansion properties of the razor 10 itself. That is, as compared to the first layer 20, the material composition of the base layer 22 is formed so that the thermal expansion coefficient of the base layer 22 more closely matches the thermal expansion coefficient of the head portion 18 of the razor 10. Preferably, the fillers which are added to the base layer 22 more closely match the thermal expansion coefficient of the head portion 18 of the razor 10, as compared to the first layer 20.

The nature and percentage of composition of the ingredients of the base layer 22 may therefore be adjusted in dependence upon the material from which the head portion 18 of the razor 10 is constructed, such as a plastic or polymer material or a metallic material. Moreover, the base layer 22 may contain less of any lubricious agents present in the first layer 20, as discussed above, in order to increase the rigidity or stiffness of the base layer 22. In this manner, the base layer 22 may be more easily secured to the razor 10 utilizing either adhesion techniques and materials, or through mechanical means, as will be discussed in more detail later.

It is therefore an important aspect of the present invention that the comfort strip 14 is comprised of at least two layers, the first layer 20 and the base layer 22, whereby the first layer 20 and the base layer 22 have differing material compositions from one another. Moreover, it is another important aspect of the present invention that the thermal expansion coefficient of the base layer 22 more closely matches the thermal expansion coefficient of the head portion 18 of the razor 10 than does the thermal expansion coefficient of the first layer 20, in order to promote a secure attachment to the head portion 18 of the razor 10. The present invention also envisions that the first layer 20 and the base layer 22 may be formed separately and mated to one another through the use of heat or the like, or may alternatively be co-extruded as a unitary element.

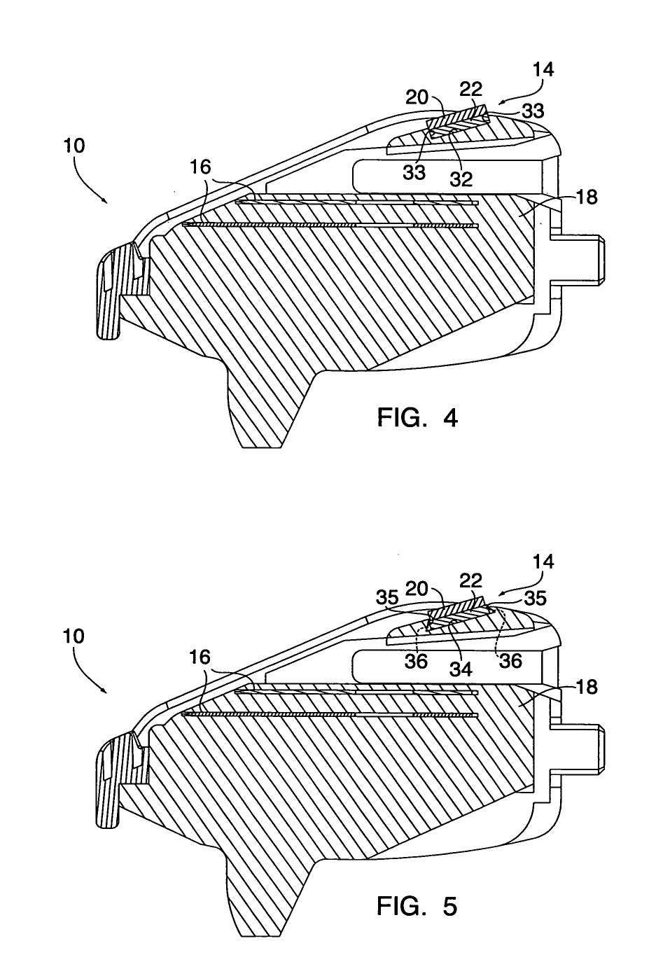

Although FIG. 2 illustrates the first layer 20 and the base layer 22 being mounted on the surface of the head portion 18, the present invention is not limited in this regard as alternative mounting regimens are also contemplated by the present invention, such as by embedding the base layer 22 in the head portion 18, as will be more completely described in conjunction with FIGS. 4-6. The base layer 22 of the comfort strip 14 may also be directly bonded to the head portion 18 via the application of heat or extruded onto the head portion 18 and then allowed to cure.

As shown in FIG. 3, the comfort strip 14 is fixed to the head portion 18 via an adhesive layer 30. In practice, the reduced lubricity and increased rigidity of the base layer 22 results in a greater and more stable bond between the head portion 18 and the base layer 22, while the first layer 20 confers the benefits of shaving aids to the skin of a user of the razor 10.

As shown in FIGS. 4-6, various mechanical or structural mechanisms are shown for securely fixing the comfort strip 14 to the head portion 18 of the razor 10. As shown in FIG. 4, a simple channel 32 having substantially perpendicular opposing side walls 33 may be formed in the head portion 18 for securing the comfort strip 14 therein. By forming the simple channel 32 to be slightly smaller in width than the base layer 22, the increased rigidity of the base layer 22 will produce an effective friction fit between these elements, thereby securing the comfort strip 14 to the head portion 18. The first layer 20 may extend, either partially or completely, above the surface of the head portion 18 in order to contact a person's skin during a shaving operation.

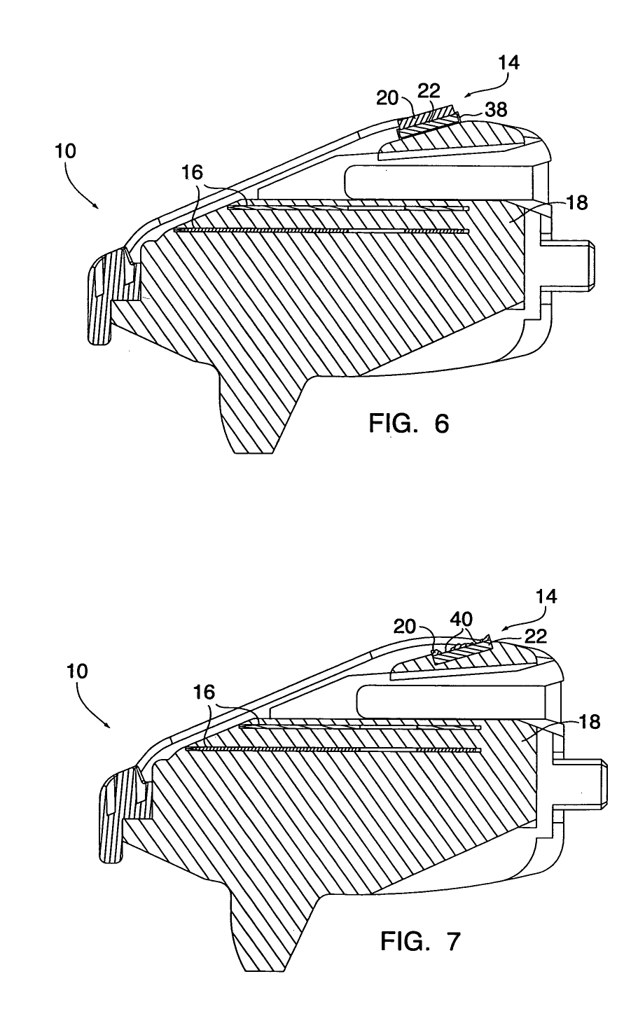

As shown in FIG. 5, the above-described channel can have inclined, generally opposed side walls 35, thereby forming an angled channel 34. The angled channel 34 will prohibit the comfort strip 14 from becoming disengaged from the angled channel 34 during use. The comfort strip 14 of FIG. 5 is formed such that the base layer 22 is somewhat wider than the first layer 20 to prevent disengagement with the angled channel 34. Moreover, the base layer 22 may have either squared sides or, alternatively, angled sides 36 (shown in phantom) to match the contours of the angled channel 34.

FIG. 6 illustrates yet another structural securing mechanism whereby the head portion 18 defines a raised channel 38 in which the comfort strip 14 may be disposed. Similar to the embodiment shown in FIG. 5, the comfort strip 14 is formed such that the base layer 22 is somewhat wider than the first layer 20 to prevent disengagement with the raised channel 38 during a shaving operation.

The present invention contemplates combining one or more features from each of the securing mechanisms of FIGS. 3-6 without departing from the broader aspects thereof. For example, any of the securing mechanism may also include the addition an adhesive or epoxy layer/agent to better secure the comfort strip 14 in the channel. Moreover, the raised channel 38 shown in FIG. 6 may also include angled sidewalls, as previously depicted in conjunction with FIG. 5.

Turning now to FIG. 7, the comfort strip 14 also provides a passive signaling mechanism for alerting the user of the razor 10 to a depletion of the first layer 20. That is, by imbuing the first layer 20 and the base layer 22 with contrasting colors, a user may be readily apprised when portions of the first layer 20 have become substantially eroded. As shown in FIG. 7, eroded areas 40 of the first layer 20 will permit the coloration of the base layer 22 to become visible to the user, thus indicating that a replacement razor, or a replacement head portion 18 or cartridge, is required.

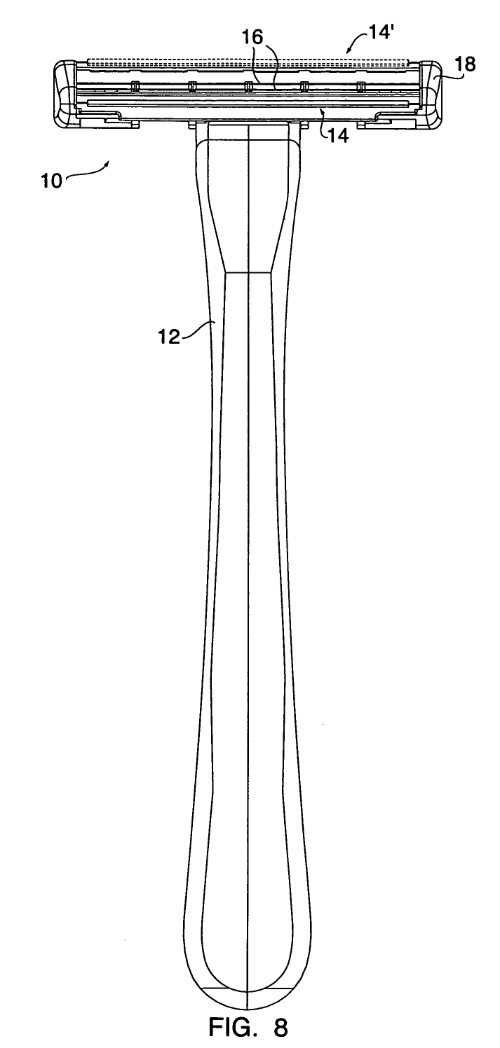

While the present invention has been described in conjunction with a razor 10 which includes a comfort strip 14 mounted adjacent to the blade elements 16 during use, the present invention is not limited in this regard. As shown in FIG. 8, the comfort strip 14 is mounted forward of the blade elements 16 in order to contact the skin of a user prior to the blade elements 16 acting on any hair protruding therefrom. Alternatively, the razor 10 may further include both forward and rear comfort strips 14 and 14′, without departing from the broader aspects of the present invention.

As depicted in the embodiments of FIGS. 1-8, the present invention proposes a multi-layered comfort strip which utilizes the material properties of the base layer to provide for the effective bonding of the comfort strip to the razor body. That is, the present invention proposes to provide a different material composition of the base layer of the comfort strip, as compared to the material composition of the first layer, in order to optimize the base layer's thermal expansion properties to more closely align with the thermal expansion properties of the razor body. Preferably, the base layer is more rigid which, in turn, aids in any mechanical or structural fastening of the base layer to the razor body. Moreover, by imbuing each of the comfort strip's layers with contrasting coloration, the present invention advantageously permits a user to determine when the first layer of the comfort strip has been substantially depleted via a visual indication.

While the invention had been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A multi-layered comfort strip secured to a razor body, said multi-layered comfort strip comprising:
a first layer having a first material composition, said first material composition having a first thermal expansion coefficient;
a second layer mated to said first layer, said second layer having a second material composition and being secured to said razor body, said second material composition having a second thermal expansion coefficient; and
said second thermal expansion coefficient more closely matches a thermal expansion coefficient of said razor body than does said first thermal expansion coefficient.

2. The multi-layered comfort strip according to claim 1, wherein:
said first material composition includes a first concentration of a shaving aid;
said second material composition includes a second concentration of said shaving aid which is less than said first concentration of said shaving aid.

3. The multi-layered comfort strip according to claim 2, wherein:
said shaving aid includes one of a cream, an oil and a soap.

4. The multi-layered comfort strip according to claim 1, wherein:
said second layer is more rigid than said first layer.

5. The multi-layered comfort strip according to claim 1, wherein:
said multi-layered comfort strip is secured to a head portion of said razor body, said head portion supporting a blade of said razor; and
said multi-layered comfort strip is secured adjacent to said blade.

6. The multi-layered comfort strip according to claim 1, wherein:
said multi-layered comfort strip is secured to a cartridge of said razor body, said cartridge supporting a blade of said razor; and
said multi-layered comfort strip is secured adjacent to said blade.

7. The multi-layered comfort strip according to claim 5, wherein:
said multi-layered comfort strip is secured to said head portion by an adhesive.

8. The multi-layered comfort strip according to claim 5, wherein:
said multi-layered comfort strip is secured a channel formed in said head portion.

9. The multi-layered comfort strip according to claim 8, wherein:
said channel includes substantially perpendicular opposing side walls.

10. The multi-layered comfort strip according to claim 8, wherein:
said channel includes angled opposing side walls.

11. The multi-layered comfort strip according to claim 5, wherein:
said multi-layered comfort strip is secured in a raised channel formed in said head portion.

12. The multi-layered comfort strip according to claim 8, wherein:
said second layer is substantially disposed within said channel; and
said first layer is substantially disposed outside of said channel.

13. The multi-layered comfort strip according to claim 1, wherein:
said first layer and said second layer are coextruded.

14. The multi-layered comfort strip according to claim 1, wherein:
said first layer and said second layer have contrasting colorations.

15. A method for providing a comfort strip to a razor, said method comprising the steps of:
forming a first layer of material having a first thermal expansion coefficient;
forming a second layer of material that incorporates a filler, said second layer having a second thermal expansion coefficient; wherein said second thermal expansion coefficient more closely matches a thermal expansion coefficient of said razor than does said first thermal expansion coefficient;
mating said base layer to said lubricating layer; and
securing said base layer to a portion of said razor.

16. The method for providing a comfort strip to a razor according to claim 15, said method further comprising the steps of:
including a first predetermined amount of shaving aids in said first layer of material;
including a second predetermined amount of said shaving aids in said second layer; and
ensuring that said second predetermined amount of said shaving aids is less than said first predetermined amount of said shaving aids.

17. The method for providing a comfort strip to a razor according to claim 16, said method further comprising the steps of:
utilizing an adhesive to secure said second layer to said razor.

18. The method for providing a comfort strip to a razor according to claim 17, said method further comprising the steps of:
inserting said second layer into a channel formed in said razor.

19. The method for providing a comfort strip to a razor according to claim 15, said method further comprising the steps of:
forming said first layer and said second layer to have contrasting colorations.

20. The method for providing a comfort strip to a razor according to claim 15, said method further comprising the steps of:
ensuring that a predetermined thermal expansion coefficient of said filler more closely matches said thermal expansion coefficient of said razor than does said first thermal expansion coefficient.

21. A multi-layered comfort strip secured to a razor body, said multi-layered comfort strip comprising:
a first layer;
a second layer mated to said first layer, said second layer being secured to said razor body; and
wherein a first material composition of said first layer differs from a second material composition of said second layer.
